(19) United States
(12) Patent Application Publication
(10) Pub. No.: US 2002/0111909 A1
(43) Pub. Date: Aug. 15, 2002

(54) Method and system for ticket purchasing and issuing using IC card

(76) Inventor: Jongho Lee, Seoul (KR)

Correspondence Address: Chung K. Ko, 4677 Old Ironside Dr. #260, Santa Clara, CA, 95054, US

(21) Appl. No.: 10/074,450

(22) Filed: Feb. 11, 2002

(30) Foreign Application Priority Data
Feb. 13, 2001 (KR) 10-2001-006888

(51) Int. Cl. G06F 17/60

(52) U.S. Cl. 705/50

(57) ABSTRACT

A method and system for issuing tickets for obtaining goods and services using an IC card is disclosed. The method includes the steps of purchasing online a ticket from a ticket issuer, transmitting from the ticket issuer to the ticket purchaser an e-ticket containing information about the ticket purchased, wherein the e-ticket is integrated with the ownership of the ticket transferred at the time of the purchase so that the e-ticket is negotiable for any further transactions, and recording the e-ticket information onto an IC card. The method further includes the steps of reading the e-ticket information from the IC card presented by a user presenting the IC card, dispensing a physical ticket based on the e-ticket information, and updating the e-ticket information on the IC card to reflect the ticket issuance. Because the e-ticket is negotiable for further transactions, it can be sent to another for gift or resale. The present invention has the advantages of increasing user convenience and safety in ordering tickets online and reducing cost for ticket service providers.

### BACKGROUND OF THE INVENTION

1. Technical Field

This invention in general relates to ticket dispensing systems and methods. More specifically, the present invention relates to a system and method for ticket purchasing and issuing online using an IC card.

2. Description of Related Art

As the use of the Internet proliferates, many users are interested in purchasing or reserving tickets through the Internet. Ticket transactions are currently being performed on the Internet, but the inconvenience of receiving actual tickets off-line still remains.

A conventional online ticket purchase and reservation method works as follows: A user using a computer terminal connects to a home page of a ticket service provider that administers ticket sales. Through the home page, the user either reserves or purchases a ticket that allow the user to obtain or use a particular service or good at a certain time and place. The user may then request the ticket service provider to send the physical ticket by mail or other off-line means. However, the savings and convenience gained by ordering tickets online is offset by the cost and inconvenience involved in the offline delivery. Not only such off-line delivery takes some time, but also the service and delivery fees charged to the user is quite high. As a result, there is a tremendous patron dissatisfaction with today's ticketing options and costs.

Alternatively, the user may request the service provider to transmit to the user a certificate containing the user's personal information or a reservation number. When the user's terminal receives the information, the user either prints the ticket certificate for later exchange with a physical ticket or writes down the reservation number. The user presents the ticket certificate or the reservation number along with the user's identification to a corresponding ticket counter such as a theatre ticket booth or a train ticket counter. The ticket counter person will then issue a physical ticket after checking the certificate or reservation number as well as the personal identification.

Although the conventional method has the advantage of eliminating the inconvenience of visiting a ticket counter for reservation of a ticket, there is still some inconvenience associated with the method. For example, the user has to take the certificate or the reservation number to the ticket counter and stand in line to wait for his turn to present his identification and receive a physical ticket. In the case of a ticket where there is a predetermined time of use such as a theatre ticket with a performance time or a train ticket with a departure time, those who purchased or reserved tickets online tend to arrive at the ticket counter shortly before the time of use. As a result, more people tend to be waiting in line at the ticket counter closer to the time of use. To alleviate the problem, the service provider may have to bear the burden of increasing the number of ticket counters and the persons working there.

Therefore, there is a need for an efficient and cost effective method and system for making online purchase and reservation of tickets as conveniently as possible.

### OBJECTS AND SUMMARY OF THE INVENTION

It is an object of the present invention to provide an efficient solution for making online purchase of tickets possible.

It is another object of the present invention to make online purchase of tickets as securely as possible.

It is yet another object of the present invention to make online purchase of tickets as negotiable as possible for any further transactions such as transferring it to others for a gift or resale.

The above-mentioned and other objects are achieved by the present invention that uses an Integrated Circuit Card (“IC card”) for storing and modifying ticket information. The method includes the steps of: purchasing online a ticket from a ticket issuer using an on-line connection, transmitting from the ticket issuer to the ticket purchaser ticket an e-ticket containing information about the ticket purchased, wherein the e-ticket is integrated with the ownership of the e-ticket transferred at the time of the purchase so that the e-ticket is negotiable for any further transactions, recording the e-ticket information onto an IC card, reading the e-ticket information from the IC card presented by a user presenting the IC card, issuing a physical ticket based on the e-ticket information, and updating the e-ticket information on the IC card to reflect the ticket issuance. The present invention has the advantages of increasing user convenience and safety in ordering tickets and reducing cost for ticket service providers.

### BRIEF DESCRIPTION OF THE DRAWINGS

FIG. 1 is a schematic diagram of an embodiment of online ticket purchase and issuing using an IC card.

FIG. 2 is a block diagram of a system for online ticket purchase and issuing using an IC card.

FIG. 3 is a flow chart showing the process of recording e-ticket information on an IC card.

FIG. 4 is a flow chart showing the process of modifying e-ticket information recorded on an IC card.

FIG. 5 is a flow chart showing the process of issuing a physical ticket based on the e-ticket information record on an IC card.

FIG. 6 is an illustration of ticket delivery through a transaction center.

FIG. 7 is a schematic diagram of an embodiment of online issuance and presentation of an e-coupon using an IC card.

### DETAILED DESCRIPTION OF THE INVENTION

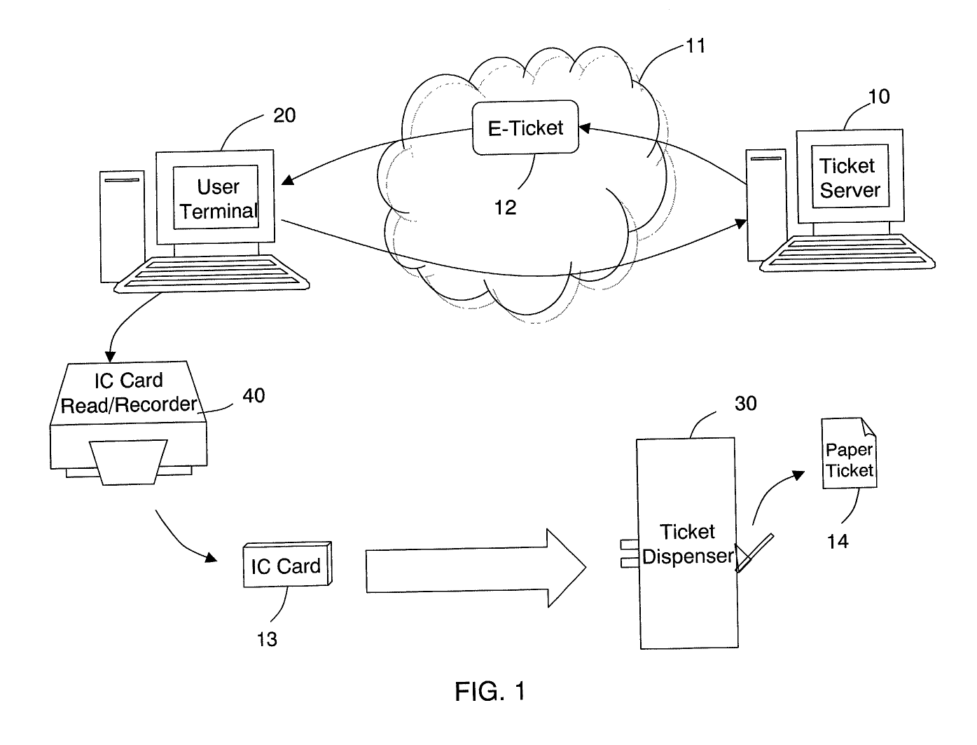

FIG. 1 shows a preferred embodiment of the present invention. A user using a terminal 20 connects through a communication connection 11 such as the Internet to a ticket server 10 either to purchase or reserve a ticket for obtaining or using goods or services. For example, the ticket may be for an admission to a concert or to riding a train. The ticket server 10 sends an electronic ticket (“e-ticket”) 12 containing the information about the ticket purchased to the user's terminal 20. Attached to the user terminal 20 is an Integrated Circuit Card (“IC card”) reader/recorder 40 for reading and recording the e-ticket information on an IC card.

The e-ticket is “negotiable” in the sense that it is freely transferable unhindered in any further transactions. Since the e-ticket contains all the information of a paper ticket, the e-ticket may be sent to others for a gift or resale before a physical ticket is received.

In conventional methods, even if a customer orders a ticket online, it is difficult for the customer to ascertain or assert the ownership of the ticket ordered until a physical ticket is received by mail or similar means. The present invention is distinguished from the conventional methods in that the ownership of the ticket is transferred at the time of payment clearance or settlement because the ownership is integrated with the e-ticket information so that the e-ticket is negotiable as freely as the corresponding physical ticket. This early severance of ownership enhances flexibility of further transactions such as ticket resale or sending tickets for gift.

The IC card, also known as a smart card, contains one or more integrated circuits. A typical IC card has a Central Processing Unit (CPU) for performing calculations, and memory that includes a Read-Only Memory (ROM) for storing an operating system for running the CPU and a Random Access Memory (RAM) for temporary storage. It also includes an EEPROM for storing application-specific information such as e-ticket information. For more details on the IC card, please refer to “Smart Cards: A Case Study,” by Jorge Ferrai et al. published Oct. 7, 1998.

Preferably, close to the time to use the ticket, be it a concert start time or a train departure time, the user takes the IC card 13 to a ticket dispenser 30, a machine that reads the IC card 13 to dispense a physical ticket 14.

The connection between the user terminal 20 and the ticket server 10 may be a point-to-point connection or a network connection, either of which may include wired or wireless connection.

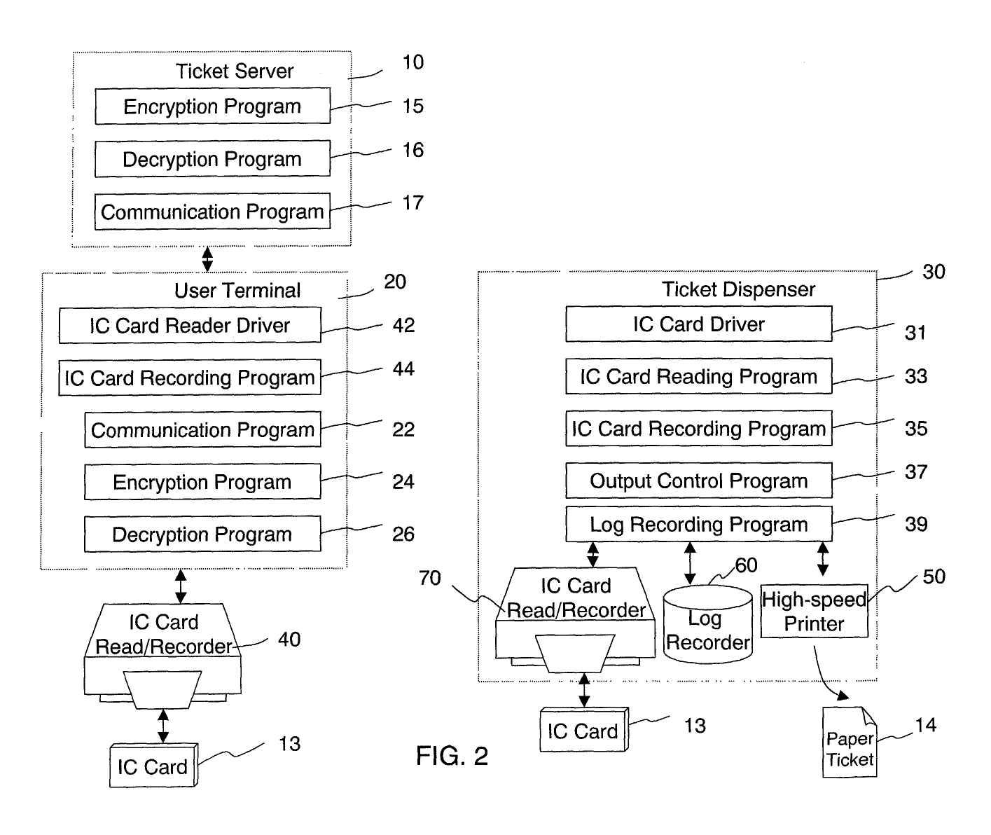

FIG. 2 shows the block diagram of the system of the present invention. The ticket server 10 may preferably include an encryption program 15 for encrypting the e-ticket information to be sent to the as well as encrypting a message to the user in a secure form, a decryption program 16 for decrypting any encrypted message from the user, and a communication program 17 for enabling communication of messages and e-ticket information to and from the user terminal 20.

The user terminal 20 preferably runs a communication program 22 for enabling communication to and from the ticket server 10, an encryption program 24 for encrypting a message to the ticket server for secure communication, and a decryption program 26 for decrypting any encrypted message or information from the ticket server. As mentioned above, attached to the user terminal 20 is an IC card reader/recorder 40.

The user terminal 20 also runs an IC card driver 42 for controlling the IC card reader 40 and an IC card recording program 44 for recording the e-ticket information received from the ticket server preferably in an encrypted form on the IC card 13.

The e-ticket 12 contains information about services and goods that can be obtained or used using the ticket, such as the name of the service, time and place of the use. As mentioned before, the e-ticket is negotiable to make it freely transferable so that the user can sent it to others as a gift or resale.

The ticket dispenser 30 includes a high-speed printer 50 for printing physical paper tickets, a log recorder 60 for recording the logs of ticket dispensing history, and an IC card reader/recorder 70 for reading the IC card 13 presented by the user.

Running on the ticket dispenser 30 is an IC card driver 31 for controlling the IC card reader/recorder 70, an IC card reading program 33 for reading the e-ticket information from the IC card, an IC card recording program 35 for recording the e-ticket information on the IC card or modifying the e-ticket information, an output control program 37 for controlling the high-speed printer 50, and a log recording program 39 for recording the logs of ticket dispensing history on the log recorder 60. The logs may, for example, be used as a reference for preventing any unauthorized attempt to re-print any previously-printed ticket.

In another preferred embodiment, the ticket dispenser 30 has a display (not shown) that displays information about multiple tickets available and allows the user to select a particular ticket among the multiple tickets.

For security, the e-ticket information may be encrypted before being recorded on the IC card. In that case, the ticket dispenser 30 should be able to decrypt the e-ticket information before dispensing a ticket.

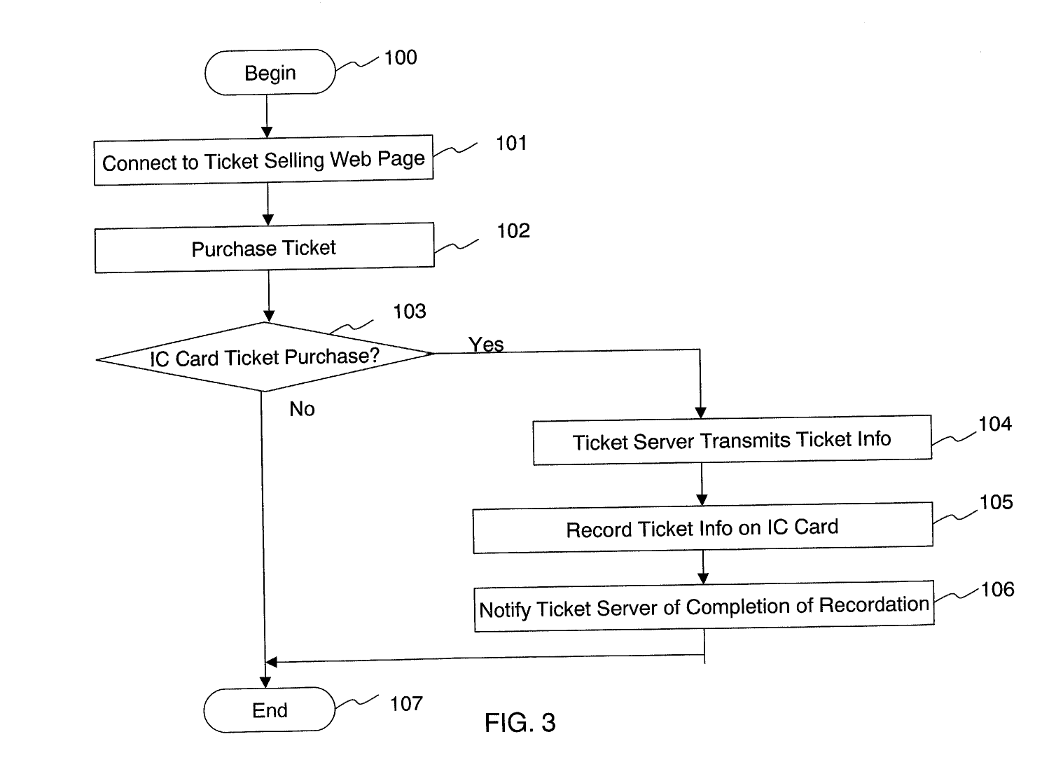

FIG. 3 shows the flow chart of the software that implements the process of recording e-ticket information on an IC card. At the start (step 100), the user connects to the ticket server 10 of his choice at step 101 preferably through the Internet and purchases a ticket online at step 102. The payment may be made using a conventional method such as using a credit card, typically used in online shopping.

Alternatively, the payment may be made using a new form of electronic or cyber money such as CyberCash™ or Mondex™. Alternatively, the IC card of the present invention may be used to contain electronic money (“e-money”) so that the payment may be made using the IC card.

Not only the IC card 13 may contain e-money but also it may contain reward points or “mileage points” accumulated over a series of purchases for the benefit of the purchaser. In that case, the reward points or mileage points may also be used toward payment of a good or service.

If the payment is settled at step 103, the ticket server 10 sends the e-ticket information to the user terminal 20 at step 104. Upon receiving the e-ticket information, the user records the e-ticket information on an IC card at step 105. When the recordation is complete, the user terminal 20 sends a completion message to the ticket server 10 at step 106.

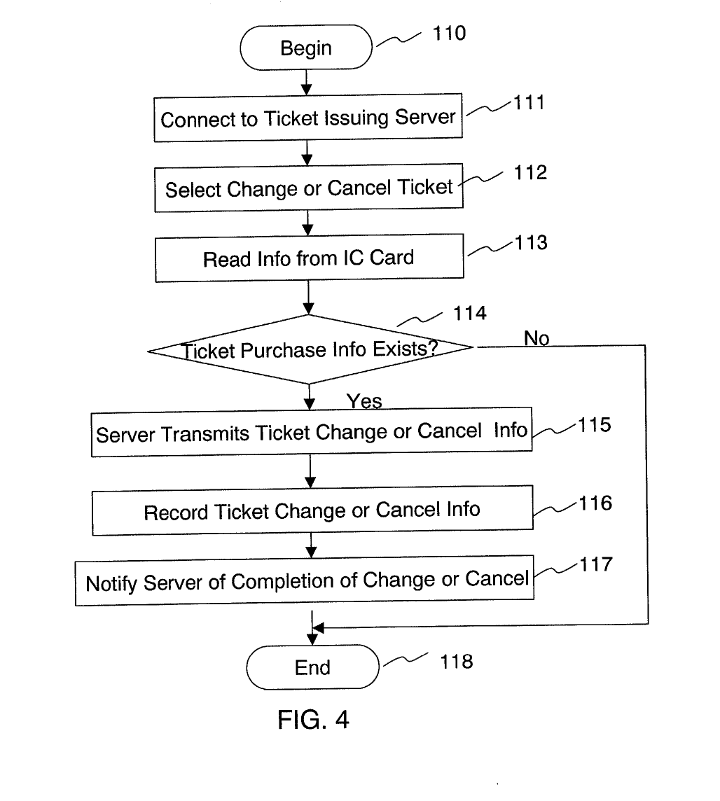

FIG. 4 shows the flow chart of the software that implements the process of modifying the e-ticket information previously recorded on an IC card. At the start (step 110), a user connects to the ticket server 10 from which the user purchased the ticket but has not used yet. At step 112, the user indicates whether the user desires to either change the ticket, such as changing the departure date of a train ticket, or cancel the ticket. The ticket server then consult the e-ticket information recorded on the IC card at step 113. If the ticket server determines at step 114 that there is valid e-ticket information on the IC card, the ticket server 10 transmits at step 115 a ticket modification message to the user terminal 20, which either changes or cancels the e-ticket information at step 116. When the modification is complete, the user terminal 20 sends a completion message to the ticket server 20 at step 117.

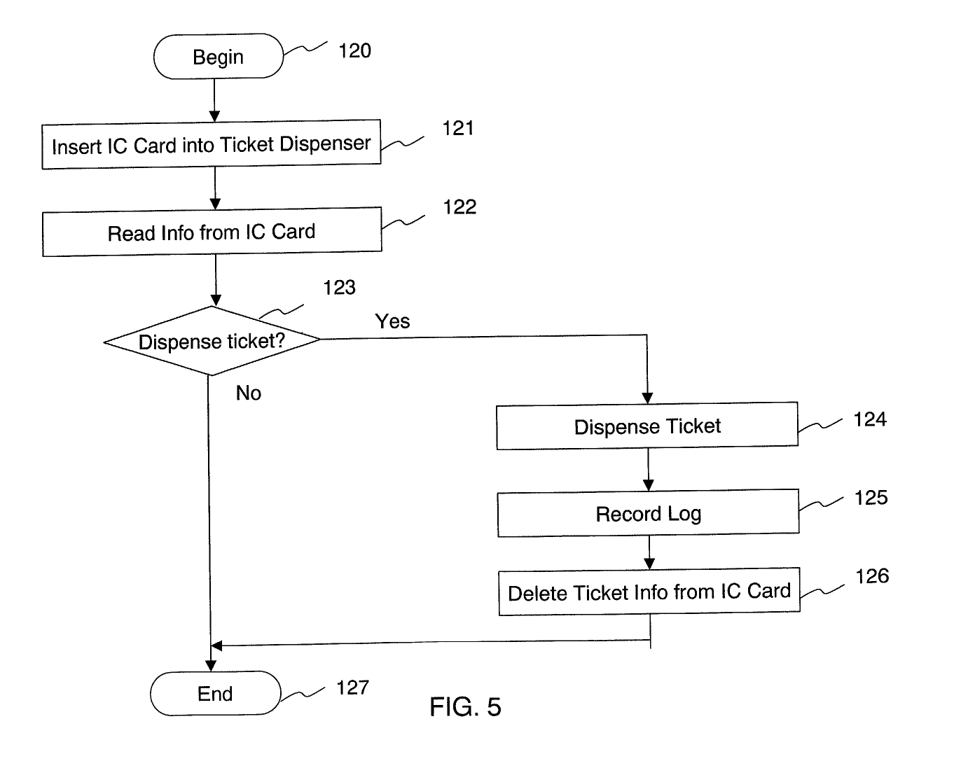

FIG. 5 shows the flow chart of the software that runs on the ticket dispenser 30 to implement the process of dispensing a physical ticket. After the software initialization (step 120), the IC card is inserted into the IC card reader/recorder 70 of the ticket dispenser 30 at step 121. The IC card reader/recorder 70 reads information contained on the IC card at step 122. If the software determines that a paper ticket should be dispensed at step 123, it proceeds to dispense a paper ticket at step 124 and records the ticket dispensing history as a log at step 125. Then the e-ticket information on the IC card is modified at step 126 to reflect the issuance of the ticket.

In another preferred embodiment, the e-ticket information includes information about multiple tickets available. In that case, there will be an additional step where the user is presented with a choice to select a desired ticket among the multiple tickets.

The e-ticket information may further include personal identity information or a secret code so that the ticket dispenser 30 can verify the identity of the user presenting the IC card by asking the personal identify information or the secret code. The ticket will be printed only when such information or secret code matches.

In addition to or as an alternative to the above method of verifying the personal identity, each IC card may be assigned a unique card ID for a security purpose. The ticket is printed only if the unique ID of the IC card presented is the same as the IC card ID secretly recorded as part of the e-ticket information on the IC card.

Although a user preferably receives the e-ticket information through the user's terminal, the present invention is limited to such. For example, a user may use a terminal for Internet phone installed in a public place to purchase or reserve a ticket online. Or a user may use a terminal integrated to a ticket dispenser to purchase or reserve a ticket online.

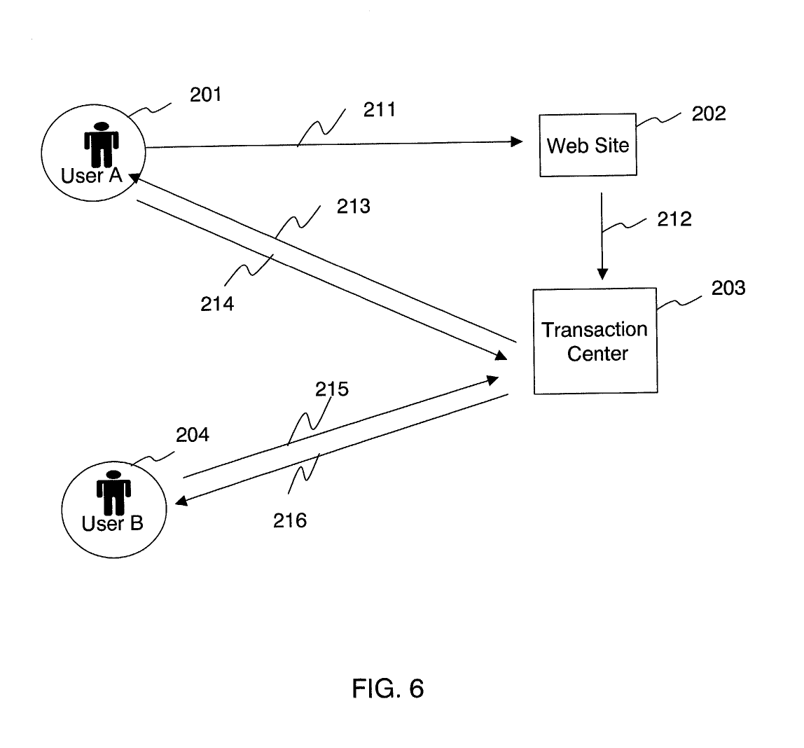

FIG. 6 illustrates e-ticket delivery for gift or resale through a transaction center. As mentioned above, the e-ticket is negotiable for further transfer as a gift or resale. Ticket delivery in such cases may be done preferably through a transaction center, which acts an intermediary to facilitate the handling of online delivery. For example, user A 201 connects to a ticket selling web site 202 to make a request 211 for reserving or purchasing a ticket. The web side 202 then sends the information 212 to the transaction center 203 that transmits a coded e-ticket 213 to user A 201. User A 201 then decides to give his ticket to user B 204 as a gift. User A 201 makes a request 214 to the transaction center to deliver the e-ticket he purchased to user B 204 as a gift. The transaction center 203 sends a notice to user B 204 asking whether to accept the gift or not. If user B accepts, the transaction center sends the e-ticket 216 to user B 204. As an alternative embodiment, user A 201 may directly send an e-ticket to user B 204, but it may be necessary that both users are connected at the same time so that the e-ticket information is properly deleted from user A's IC card while the e-ticket information is added to user B's IC card.

In the case of resale, the transaction center may act as an exchange place where ticket holders advertise their tickets for resale to potential buyers. The transaction center may also act as a clearing house to settle the payment between ticket sellers and ticket buyers.

The preferred embodiments have been described in connection with e-tickets for allowing purchase of goods or services, but the present invention may also be applied to electronics coupons (“e-coupons”). In general, coupons are used to purchase goods or services at discount or bargain prices. The technology of the present invention may be used to download e-coupon information on an IC card so that it can be conveniently carried for later use.

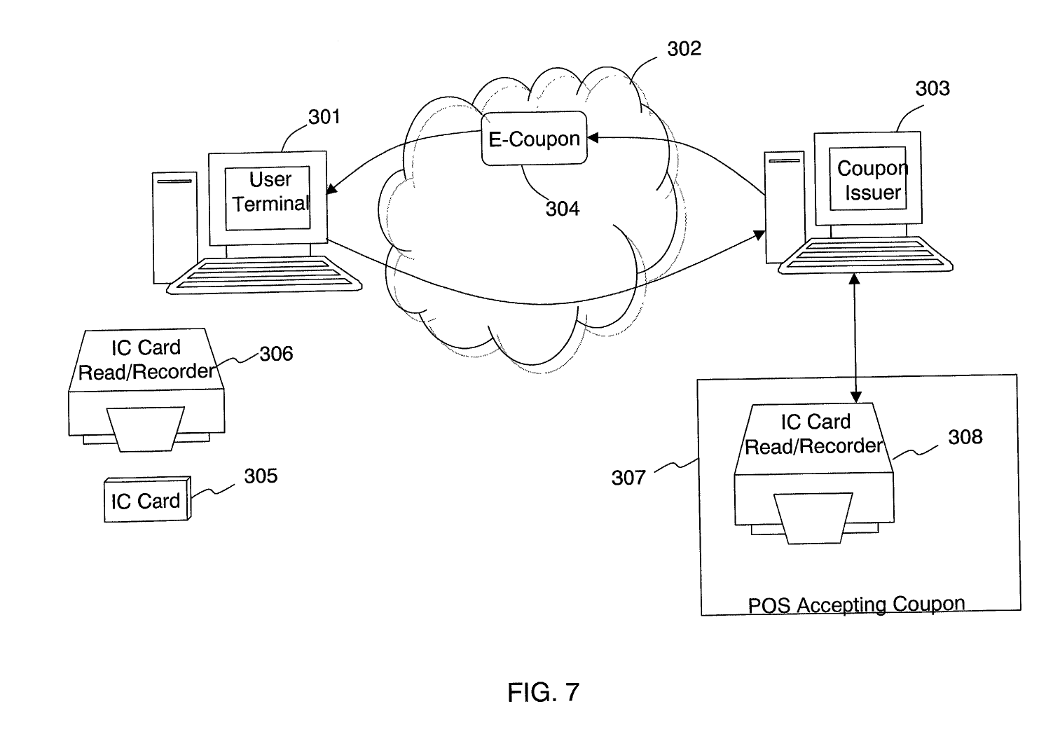

FIG. 7 shows an example where a user 301 having an IC card 305 connects through the Internet 302 to a coupon issuer 303 issuing e-coupons and downloads an e-coupon 304 on the user's IC card 305 using an IC card reader/recorder 306. Then the user takes the IC card to a point-of-sale (“POS”) 307 where the e-coupon 304 is accepted. Located at POS 307 is an IC card reader/recorder 308 that reads the user's IC card 305 to validate the e-coupon 304 so that the user can buy a desired item at discount. The payment may be made using a credit card or the IC card storing electronic money. Alternatively, the payment may be made using the reward points accumulated for the benefit of the user.

Although the preferred embodiments above have been described using the IC card as an example, the invention is limited to such. Those skilled in the art would readily realize that other kinds of media may be used if they can store digitized information that can be read and modified. For example, a stick-shaped flash memory may be used that can be connected to a desktop PC or notebook PC through a USB port.

While the invention has been described with reference to preferred embodiments, it is not intended to be limited to those embodiments. It will be appreciated by those of ordinary skilled in the art that many modifications can be made to the structure and form of the described embodiments without departing from the spirit and scope of this invention.

What is claimed is:

1. A method for dispensing a ticket for obtaining goods or services, comprising the steps of:
purchasing a ticket from a ticket issuer connected to a ticket purchaser through a communication connection;
transmitting from the ticket issuer to the ticket purchaser an e-ticket containing information about the ticket purchased, wherein the e-ticket is integrated with the ownership of the e-ticket transferred to the ticket purchaser at the time of the purchase so that the e-ticket is negotiable for any further transactions;
recording the e-ticket information received by the ticket purchaser on an IC card;
reading the e-ticket information recorded on the IC card presented by a ticket user carrying the IC card;
dispensing a physical ticket based on the e-ticket information read from the IC card; and
updating the e-ticket information on the IC card reflecting the ticket issuance.

2. The method of claim 1, wherein the ticket user is the ticket purchaser.

3. The method of claim 1, wherein the ticket user is different from the ticket purchaser.

4. The method of claim 1, wherein the communication connection includes a wired connection.

5. The method of claim 1, wherein the communication connection is through the Internet.

6. The method of claim 1, wherein the communication connection includes a wireless connection

7. The method of claim 1, further comprising the step of:
reserving a ticket to be purchased before the step of purchasing.

8. The method of claim 1, wherein said purchasing is made using a credit card.

9. The method of claim 1, wherein said purchasing is made in electronic money.

10. The method of claim 1, wherein said purchasing is made using reward points accumulated for the benefit of the ticket purchaser.

11. The method of claim 1, further comprising the steps of:
requesting modification of ticket information from the ticket purchaser to the ticket issuer;
transmitting the modification information from the ticket issuer to the ticket purchaser; and
modifying the ticket information on the IC card to reflect the ticket modification.

12. The method of claim 1, wherein said step of transmitting further includes the step of encrypting said e-ticket information before transmission.

13. The method of claim 12, wherein said step of reading the e-ticket further includes the step of decrypting the encrypted e-ticket information before reading.

14. The method of claim 1, wherein said step of recording further comprises the step of encrypting said received e-ticket information before recording.

15. The method of claim 14, wherein said step of reading the e-ticket further includes the step of decrypting the encrypted e-ticket information before reading.

16. The method of claim 1, wherein said IC card is identified by a unique ID, and said e-ticket information includes the ID of the IC card to be presented by the ticket user.

17. The method of claim 16, further comprising the steps of:
identifying the unique ID of the IC card presented by the ticket user; and
comparing the unique IC card ID with the ID included in the ticket information read from the IC card for security check.

18. The method claim 1, wherein the ticket information includes ticket user's personal information.

19. The method of claim 18, further comprising the steps of:
asking the ticket user's personal information; and
comparing the answered personal information with the personal information included in the ticket information from the IC card.

20. The method of claim 1, wherein the e-ticket information includes reward points accumulated for allowing the ticket purchaser for purchasing a ticket in the whole or at discount.

21. A method for dispensing a ticket for obtaining goods or services, comprising the steps of:
purchasing a ticket from a ticket issuer having a ticket server connected to a ticket purchaser having a user terminal through a communication connection;
transmitting from the ticket server to the user terminal an e-ticket containing e-ticket information about the ticket purchased, wherein the e-ticket is integrated with the ownership of the e-ticket transferred to the ticket purchaser at the time of the purchase so that the e-ticket is negotiable for any further transactions;
recording the e-ticket information received by the user terminal in a recording medium;
reading by a ticket dispenser the e-ticket information from the recording medium presented by a ticket user;
dispensing a physical ticket by the ticket dispenser to the ticket user based on the e-ticket information read from the medium; and
updating the e-ticket information on the IC card reflecting the dispensing of the physical ticket.

22. The method of claim 21, wherein said medium is an IC card.

23. The method of claim 21, wherein said medium is a flash memory card.

24. The method of claim 21, wherein said medium is a rewritable disk.

25. The method of claim 21, wherein said user terminal includes a computer.

26. The method of claim 21, wherein said user terminal is located at user's premise.

27. The method of claim 21, wherein said user terminal is located in public.

28. The method of claim 21, further comprising the step of:
reserving a ticket to be purchased before the step of purchasing a ticket.

29. The method of claim 21, wherein the purchasing is made using a credit card.

30. The method of claim 21, wherein the purchasing is made in electronic money.

31. The method of claim 21, wherein the purchasing is made using reward points accumulated for the benefit of the ticket purchaser.

32. The method of claim 21, further comprising the steps of:
requesting modification of ticket information from the ticket purchaser to the ticket issuer;
transmitting the modification information from the ticket server to the user terminal; and
modifying the ticket information on the IC card to reflect the ticket modification.

33. The method of claim 21, wherein said step of transmitting further includes the step of encrypting said e-ticket information before transmission.

34. The method of claim 33, wherein said step of reading the e-ticket further includes the step of decrypting the encrypted e-ticket information before reading.

35. The method of claim 21, wherein said step of recording further comprises the step of encrypting said received e-ticket information before recording.

36. The method of claim 35, wherein said step of reading the e-ticket further includes the step of decrypting the encrypted e-ticket information before reading.

37. A method for sending a ticket for obtaining goods or services to another person as a gift, comprising the steps of:
purchasing an ticket from a ticket seller connected to a ticket purchaser through a communication connection;
transmitting from the purchaser to a recipient an e-ticket containing information about the ticket purchased, wherein the e-ticket is integrated with the ownership of the e-ticket transferred to the ticket purchaser at the time of the purchase so that the e-ticket is negotiable for any further transactions;
recording the e-ticket information received by the recipient on an IC card;
presenting the IC card by the recipient carrying the IC card; and
dispensing a physical ticket to the recipient based on the e-ticket information read from the IC card.

38. The method of claim 37, wherein said purchasing is made using a credit card.

39. The method of claim 37, wherein said purchasing is made in electronic money.

40. A method for sending a ticket for obtaining goods or services to another person as a gift, comprising the steps of:
purchasing a ticket from a ticket seller connected to a ticket purchaser through a communication connection;
transmitting information about the ticket purchased from the ticket seller to a transaction center;
transmitting from the transaction center to the ticket purchaser an e-ticket containing information about the e-ticket purchased, wherein the e-ticket is integrated with the ownership of the e-ticket transferred to the ticket purchaser at the time of the purchase so that the e-ticket is negotiable for any further transactions; and
recording the e-ticket information on a first IC card.

41. The method of claim 40, further comprising the steps of:
requesting the transaction center to send the ticket to the recipient as a gift;
modifying the e-ticket information stored in the first IC card;
notifying by the transaction center to the recipient about the gift and requesting the recipient's response as to whether the recipient wishes to accept the gift;
if the recipient accepts, transmitting from the transaction center to the recipient an e-ticket containing information about the ticket sent as a gift;
recording the e-ticket information on a second IC card;
reading the e-ticket information from the second IC card presented by the recipient; and
dispensing a physical ticket to the recipient based on the e-ticket information read from the second IC card.

42. The method of claim 40, wherein said purchasing is made using a credit card.

43. The method of claim 40, wherein said purchasing is made in electronic money.

44. A method for reselling a ticket for obtaining goods or services, comprising:
purchasing a ticket from a ticket seller connected to a first purchaser through a communication connection;
transmitting from the ticket seller to the first purchaser an e-ticket containing information about the e-ticket purchased, wherein the e-ticket is integrated with the ownership of the e-ticket transferred to the first purchaser at the time of the purchase so that the e-ticket is negotiable for any further transactions;
recording the information about the ticket purchased on a first IC card;
transmitting the e-ticket from the first purchaser to a second purchaser;
recording the e-ticket information received by the second purchaser on a second IC card;
reading the ticket information recorded in the second IC card presented by the second purchaser; and
dispensing a physical ticket to the second purchaser based on the ticket information read from the IC card.

45. The method of claim 44, wherein said purchasing is made using a credit card.

46. The method of claim 44, wherein said purchasing is made in electronic money.

47. A method for reselling a ticket for obtaining goods or services, comprising:
purchasing a ticket from a ticket seller connected to a first purchaser through a communication connection;
transmitting an e-ticket containing information about the ticket purchased from the ticket seller to a transaction center, wherein the e-ticket is integrated with the ownership of the e-ticket transferred to the first purchaser at the time of the purchase so that the e-ticket is negotiable for any further transactions;
transmitting from the transaction center to the first purchaser an e-ticket containing information about the ticket purchased; and
recording the e-ticket information on a first IC card.

48. The method of claim 47, further comprising the steps of:
requesting the transaction center to send the ticket to the second purchaser for resale;
modifying the e-ticket information stored on the first purchaser's IC card;
notifying the second purchaser about the ticket to be transmitted;
transmitting from the transaction center to the second purchaser an e-ticket containing information about the ticket sent for resale;
presenting the IC card by the second purchaser carrying the IC card; and
dispensing a physical ticket to the second purchaser based on the e-ticket information read from the IC card.

49. The method of claim 48, wherein said purchasing is made using a credit card.

50. The method of claim 48, wherein said payment is made in electronic money.

51. A system for dispensing a ticket for obtaining goods or services, comprising:
a ticket server for transmitting an e-ticket containing information about a ticket purchased by a ticket purchaser, wherein the e-ticket is integrated with the ownership of the e-ticket transferred to the ticket purchaser at the time of the purchase so that the e-ticket is negotiable for any further transactions;
an IC card for storing the e-ticket information;
a user terminal, connected to the ticket server through a communication connection, for receiving the e-ticket from the ticket server and for recording the e-ticket information to the IC card; and
a ticket dispenser for reading the e-ticket information from the IC card presented and for dispensing a physical ticket to a ticket user based on the e-ticket information read from the IC card presented by the ticket user.

52. The system of claim 51, wherein said communication connection includes a wired connection.

53. The system of claim 51, wherein said communication connection is through the Internet.

54. The system of claim 51, wherein said communication connection includes a wireless connection.

55. The system of claim 51, wherein said ticket server further comprises an encrypter for encrypting the e-ticket information before transmission to the user terminal.

56. The system of claim 55, wherein said user terminal further comprises a decrypter for decrypting the encrypted e-ticket information received.

57. The system of claim 51, wherein said user terminal further comprising an encrypter for encrypting the e-ticket information before recordation on the IC card.

58. The system of claim 57, wherein said ticket dispenser further comprises a decrypter for decrypting the e-ticket information read from the IC card.

59. The system of claim 51, wherein said ticket dispenser further comprises a user interface for checking the ID of the ticket user.

60. The system of claim 51, wherein said ticket dispenser comprises:
a display for displaying ticket information;
a keyboard for entering the ticket user's input; and
a printer for printing a physical ticket.

61. A system for dispensing a ticket for obtaining goods or services, comprising:
a ticket server for transmitting an e-ticket containing information about a ticket purchased by a ticket purchaser, wherein the e-ticket is integrated with the ownership of the ticket transferred to the ticket purchaser at the time of purchase so that the e-ticket negotiable for any further transactions;
a recording medium for storing the e-ticket information;
a user terminal, connected to the ticket server through online, for receiving the e-ticket from the ticket server and for recording the e-ticket information onto the recording medium; and
a ticket dispenser for reading the e-ticket information from the recording medium presented and for dispensing a physical ticket to a ticket user based on the e-ticket information read from the recording medium presented by the ticket user.

62. The system of claim 61, wherein said recording medium is an IC card.

63. The system of claim 61, wherein said recording medium is a flash memory card.

64. The system of claim 61, wherein said recording medium is a rewritable disk.

65. A method for issuing an electronic coupon (“e-coupon”) that can be used in conjunction with purchasing goods or services at discount, comprising the steps of:
connecting online to an e-coupon issuer and requesting the issuer to issue an e-coupon to a user;
downloading information about the e-coupon on the user's IC card; and
presenting the e-coupon information on the IC card at a point-of-sale in conjunction with purchasing a good or service; and
updating the e-coupon information on the IC card to reflect the use of the e-coupon.

66. The method of claim 65, wherein said purchasing is made using a credit card.

67. The method of claim 65, wherein said purchasing is made using the IC card.

68. The method of claim 65, wherein said purchasing is made using reward points accumulated for the benefit of the user.
